(19) United States
(12) Patent Application Publication
(10) Pub. No.: US 2007/0136776 A1
(43) Pub. Date: Jun. 14, 2007

(54) Television viewers interation and voting method

(76) Inventors: Michael Findlay, Flushing, NY (US); Josephina Diolata, Flushing, NY (US)

Correspondence Address: EDWIN TARVER, 16830 Ventura Blvd., SUITE 360, Encino, CA, 91436, US

(21) Appl. No.: 11/636,148

(22) Filed: Dec. 7, 2006

Related U.S. Application Data
(60) Provisional application No. 60/749,328, filed on Dec. 9, 2005.

(51) Int. Cl. H04N 7/173; H04N 5/445; H04N 7/16

(52) U.S. Cl. 725/113; 725/37; 725/135; 725/38; 725/110; 725/112

(57) ABSTRACT

An interaction and voting method for TV audience. A plurality of preset words, special characters and other symbols are provided for a member of the audience of a TV program to select via the Internet or telephone in order to form a message. The message is received and verified before inserting into the TV program. All the messages that can be formed are assigned specific points and the voting comprises selection of a contestant and forming the message concerning the performance of the contestant. The points of the message sent by the member are allotted to the contestant.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to methods for displaying messages on television (TV) programs, and more particularly to a TV viewer interaction and voting method via the Internet and telephone.

Certain television programs encourage viewer interaction. Many programs involving competitions require viewer votes to determine a winner. Currently, viewers go to a website or dial a number to vote for their favorite contestants. Several methods and systems that facilitate such interaction and participation by viewers are known in the art.

U.S. Pub. No. 20050289622 to Vanlerberghe discloses a method for creating original, interactive television programming. A Short Messaging System (SMS) gateway is used to route text messages from a user's wireless device through a wireless carrier to a server. The SMS data is then converted to a graphical format, which can be added to a broadcast television signal for display on a television program.

U.S. Pub. No. 20040010797 to Vogel discloses a TV audience interaction method for inserting feedback from members of the viewing public into a television program. Viewers submit reactions to programming in real time in the form of spoken or text messages. The messages are received via telephone, SMS or Internet and later incorporated into the program being watched or into a separate program broadcast subsequently. Messages received in audio format can be converted in to text messages for display on the program and vice versa.

U.S. Pat. No. 6,584,613 to Dunn discloses a simplified TV viewer response system coupled to a telephone system that enables a viewer to respond to television displays by dialing a special code less than six digits. The code is routed to an enhanced services server, which captures the dial string including the caller ID, checks the caller ID against a viewer profile and maps the caller ID to the cable company providing service to the viewer. The server delivers the response to the cable television company which processes the response according to the selected items or choices in the TV screen. Several special dialing codes of limited digits expedite viewer selections.

Although the above systems and methods facilitate viewer interaction, creating personalized messages requires a viewer to type or speak over the phone. Since there is no limit to the content and size of messages, entering them can be time consuming and awkward.

Therefore, it is an object of the present invention to provide a TV audience interaction method that is more efficient and user friendly for creating personalized messages.

A further object is to provide a TV audience interaction method that provides user interfaces accessible over the Internet for creating personalized messages.

A further object is to provide a TV audience interaction method that uses dialing codes for creating personalized messages.

Finally, it is an object of the present invention to provide a TV audience interaction method that can be used for voting based on personalized messages. These and other objects of the present invention will become better understood with reference to the appended Summary, Description, and claims.

### SUMMARY

The present invention is a method for TV viewer interaction and voting via Internet and telephone. The method facilitates creating messages for interaction with a TV program. According to the present invention, viewers are provided with a plurality of preset words and characters to select from in order to form a message.

For creating messages over the Internet, a hosting website is provided for the viewers to select a TV program and the preset words and characters on a plurality of user interfaces. Preferably, the preset words are selected from a plurality of drop down dialog boxes. For creating messages over the telephone, each preset word and character is assigned a dialing code and a viewer is guided through a plurality of voice prompts to select a TV program and form a message.

The present invention can also be used for voting in a live TV program. Each possible message is assigned specific number of points. A viewer can choose a contestant and form a message about the performance of the contestant. The points of the messages sent by the viewers will be added to determine the total number of votes for the contestant.

### BRIEF DESCRIPTION OF THE FIGURES

FIG. 1 is a flowchart of the TV viewers' interaction method via Internet in accordance with the present invention.

FIG. 2 is a flowchart of the TV viewers' interaction method via telephone in accordance with the present invention.

FIG. 3 is a flowchart of the TV viewers' voting method in accordance with the present invention.

### FIGURES—REFERENCE NUMERALS

None

### Detailed Description

The present invention provides an interaction and voting method for TV audience via the Internet and telephone. The method provides convenient features for members of the TV audience to easily create and transmit messages over the Internet or telephone.

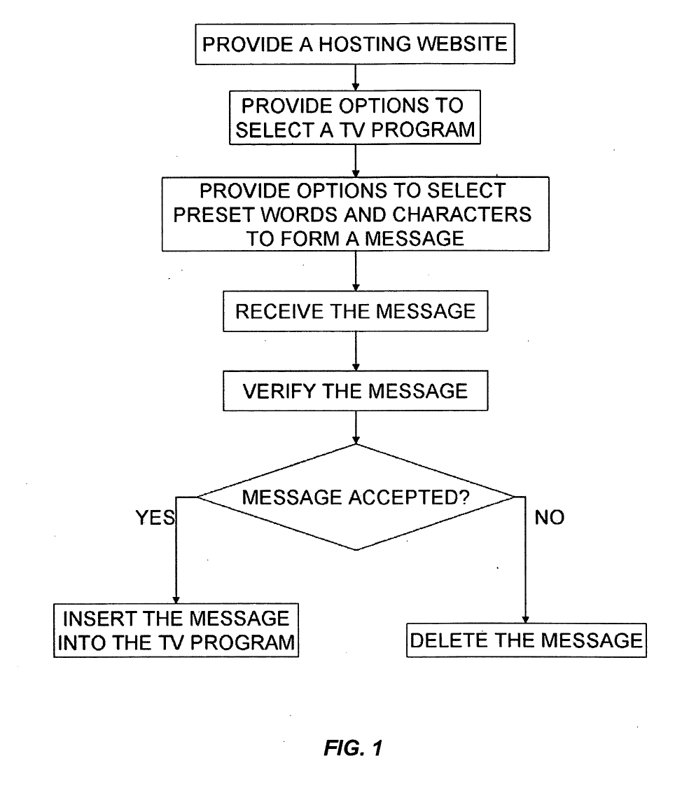

Referring to FIG. 1, the interaction method via the Internet is shown and described. A hosting website is provided for access by members of a television program audience. A member is guided through a plurality of user interfaces (not illustrated). Initially, the member is required to select a program. In accordance with the present invention, the member is not required to type the message. Instead, a plurality of preset words, special characters, and other symbols are provided on a user interface (not illustrated) for the member to select and form a message. Preferably, these preset words, special characters, and other symbols are grouped and can be selected from a plurality of dropdown dialog boxes.

After the message is formed, the member sends it to a control station by hitting a send or submit button. The message is received and computationally verified before it is incorporated into the program, which is also selected by the member. In a preferred embodiment, each of the preset words, special characters, and other symbols is assigned with multiple digit codes. The received message is verified by checking these multiple digit codes. Alternatively, a group of preset words, special characters, and other symbols can be assigned with multiple digit codes.

The verification process prevents hacking and filters the message for obscene content. If multiple digit codes match, the message is accepted. The accepted message is then incorporated into the program. The message is rejected and deleted if the multiple digit codes do not match. If a message is accepted, the message is rewritten to the corresponding codes that were received.

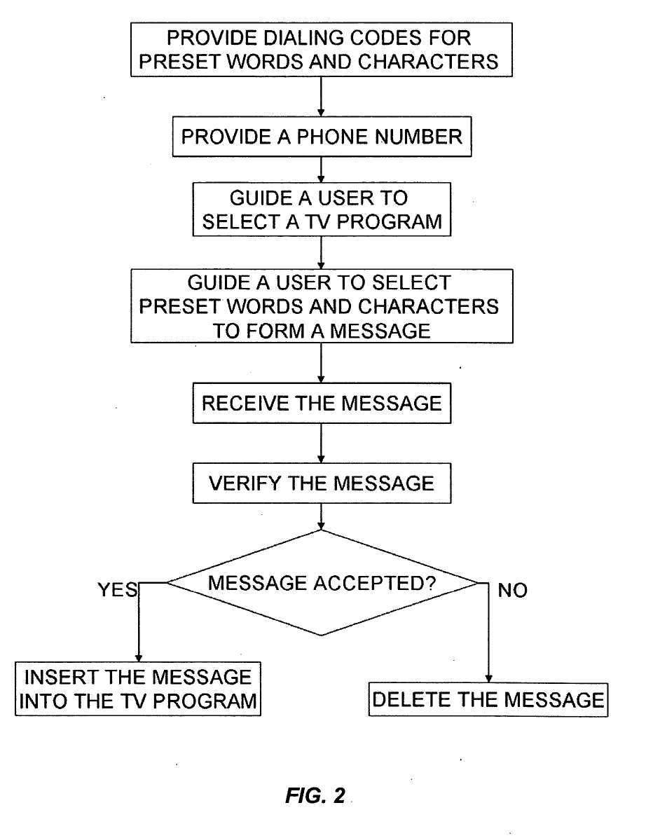

Referring to FIG. 2, the interaction method via telephone is shown and described. A member is guided through a plurality of voice prompts over the phone after dialing a phone number. In accordance with this embodiment, each of the preset words, special characters, and other symbols is assigned a number code. Members are required to dial the number codes via telephone, following voice prompts, to select the program and form the message. Members then send the message, which is received by a control station.

The TV program can also be assigned a number code for selection over the phone. Alternatively, the phone number itself can be dedicated to the TV program. Certain messages are also preset and assigned a number code. The assigned number codes are provided to the member, preferably on a website.

The received message is computationally verified before incorporation into the TV program selected by the member. The verification process explained above using multiple digit codes is also employed in this embodiment. Finally, the accepted message is inserted into the TV program.

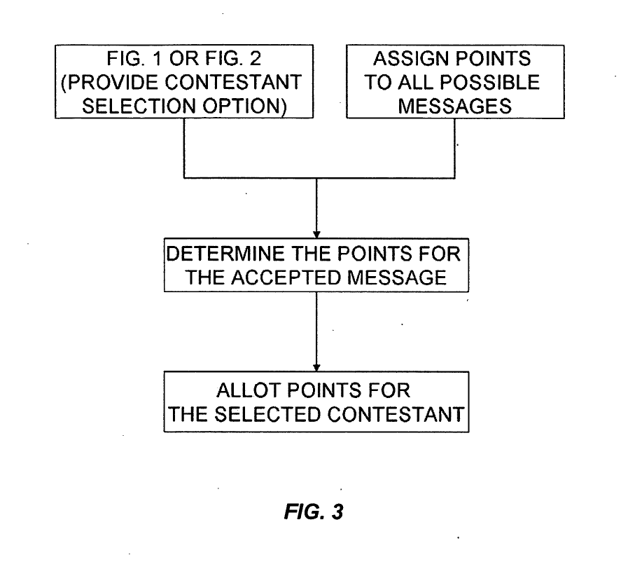

Referring to FIG. 3, the present invention also provides a method of voting. Many live TV shows involve competitions that encourage audience members to vote. The voting method involves selection of a contestant of a TV show and creating a message concerning the performance of the selected contestant. The message can be created by the interaction methods via the Internet or telephone described previously, by including a contestant selection option.

According to the voting method, each message possible by the combination of the preset words is assigned specific number of points. The number of points is determined based on the positive and negative expression or emotion of the message. Once the message is created and accepted, the points assigned to it are allotted to the selected contestant. In this way, a plurality of members can participate in the voting and the points of the messages sent by them are added to determine the total number of votes for the contestant. The contestant with the maximum number of votes is determined as the winner.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method for television (TV) audience interaction comprising the steps of:
a. providing a selection means comprising a plurality of preset symbols, including letters, words and special characters, comprising a message, selectable by an audience member of a program via the Internet or telephone in order to form a message;
b. the controller of the program receiving the message via the Internet or telephone;
c. verifying the received message; and
d. inserting the verified message into the program.

2. The method of claim 1, wherein the audience member logs onto a hosting website, selects the program and composes the message received via the Internet for inserting into the program.

3. The method of claim 2, wherein a plurality of drop down dialog boxes are provided for selecting the preset words, special characters, and other symbols.

4. The method of claim 1, wherein each of the preset words, special characters and other symbols is assigned a number code, and a member, guided through a voice prompt series via telephone, dials the number codes to form the message.

5. The method of claim 4, wherein the program is also assigned a number code
for selection via telephone.

6. The method of claim 4, wherein a phone number is assigned to the program and the member is required to dial the phone number to start forming the message.

7. The method of claim 4, wherein the assigned number codes are provided to the member.

8. The method of claim 4, wherein the member is guided through the voice prompts in order to select the program.

9. The method of claim 4, wherein at least one of the messages is preset and assigned a number code to expedite selection.

10. The method of claim 1, wherein each of the preset symbol is assigned multiple digit codes, the message being verified by analyzing the multiple digit codes.

11. The method of claim 10, wherein a group of the preset words, special characters and other symbols can also be assigned with multiple digit codes.

12. The method of claim 1, wherein the method is used for voting in a live TV program.

13. The method of claim 12, wherein all possible messages are assigned specific points and voting comprises a member selecting a program contestant via the Internet or telephone, forming the message concerning the performance of the contestant, and allotting the points of the message to the contestant.

14. The method of claim 13, wherein a plurality of members participate in voting, and the points of the messages allocated by the members are added to determine the total number of votes for a contestant.

15. The method of claim 1, wherein the name of the member is inserted corresponding to the message.

16. A method for television (TV) audience interaction and voting comprising the steps of:
a. selecting a contestant of a TV program by a member of the audience via the Internet or telephone;
b. providing a plurality of preset words, special characters and other symbols for the member to select via the Internet or telephone in order to form a message concerning the performance of the contestant;
c. assigning points to all the message possible by the combinations of plurality of preset words, special characters and other symbols
d. receiving the message via the Internet or telephone;
e. verifying the received message to prevent hacking and filter content;
f. inserting the verified message into the TV program; and
g. allotting the points of the message to the contestant.

17. The method of claim 1, wherein a hosting website is provided for the member to log on, select the TV program, the contestant, and the preset words, special characters, and other symbols.

18. The method of claim 1, wherein the member is guided through a series of voice prompts in order to select the TV program and the contestant, and each preset symbol or symbols is assigned a number code for the member to enter following the voice prompts to form the message, the assigned number codes being provided to the member.

19. The method of claim 4, wherein some of the messages are preset and assigned the number code to expedite the member's selections.

20. The method of claim 1, wherein each of the preset words, special characters and other symbols is assigned multiple digit codes, the message being verified by analyzing the multiple digit codes.
